(19) United States
(12) Patent Application Publication
(10) Pub. No.: US 2025/0295262 A1
(43) Pub. Date: Sep. 25, 2025

(54) HINGING RACK FOR INSERTING FOOD CARRIERS, FOOD TREATING DEVICE AND METHOD FOR OPERATING THE FOOD TREATING DEVICE

(71) Applicant: Welbilt Deutschland GmbH, Eglfing (DE)

(72) Inventor: Hannes WILD, Riegsee (DE)

(21) Appl. No.: 19/086,649

(22) Filed: Mar. 21, 2025

(30) Foreign Application Priority Data
Mar. 25, 2024 (EP) 24165756.8

(51) Int. Cl. A47J 27/12; A47J 36/32

(52) U.S. Cl. CPC A47J 27/12; A47J 36/32

(57) ABSTRACT

A hinging rack for inserting food carriers, in particular trays, into a food receiving chamber, includes a plurality of insertion zones arranged one above the other, wherein each insertion zone comprises at least one insertion, wherein each insertion comprises a pair of two opposing insertion elements at the same height for inserting a food carrier, wherein at least two of the insertion zones are adapted as complete insertion zones, wherein each complete insertion zone comprises a first insertion element, at which the opposing insertion elements have a first horizontal distance from one another, and wherein each complete insertion zone comprises a second insertion, wherein the opposite insertion elements have a second horizontal distance from one another, wherein the first horizontal distance is greater than the second horizontal distance.

### CROSS-REFERENCE TO RELATED APPLICATION

This application claims priority to European Patent Application No. EP24165756.8, entitled “Hinging Rack For Inserting Food Carriers, Food Treating Device And Method For Operating The Food Treating Device” and filed on Mar. 25, 2024, which is expressly incorporated by reference herein in its entirety.

### TECHNICAL FIELD

The invention relates to a hinging rack for inserting food carriers, in particular trays, into a food receiving chamber. Furthermore, the invention relates to a food treating device with the hinging rack and a method for operating the food treating device.

### BACKGROUND

Various food treating devices, for example cooking devices, are known from the prior art. These devices comprise a food receiving chamber, in which a hinging rack is provided. Food carriers, for example trays, can be inserted into the hinging rack at different heights in corresponding insertions.

### SUMMARY

It is the object of the present invention to provide a hinging rack for inserting food carriers into food receiving chambers, which enables the use of different types of food carriers. Furthermore, a method for operating the food treating device is to be specified, which enables the insertion position to be detected as accurately as possible.

This object is solved by the features of the independent claims. The dependent claims relate to preferred embodiments of the invention.

Thus, the object is solved by a hinging rack for inserting food carriers into a food receiving chamber. The food receiving chamber is, in particular, the interior of a food treating device. This device is, for example, a cooking device, warming device or cooling device. However, the food receiving chamber can also be part of a device for storing the food, for example a type of cabinet or shelf, into which the food carriers can be inserted.

The hinging rack comprises a plurality of insertion zones arranged one above the other, wherein each insertion zone comprises at least one insertion. Each insertion comprises a pair of two opposing insertion elements at the same height. The opposite edges of the food carrier are arranged on the upper sides of the insertion elements. Thus, the insertion or the opposing pairs are used for inserting a food carrier at insertion elements.

In particular, the food carrier is a tray or gastronomic standard container comprising a standardized geometry. In particular, the common containers according to the so-called “gastronomic standard system” are known. These are used as standard in the gastronomy industry and are based on standard sizes defined in relevant DIN, ISO, EN and US standards. The problem, however, is that there are minimal differences in geometry between the common DIN, EN and ISO standards and the well-known US standards. The hinging rack described here specifically refers to the different horizontal distances.

The insertion elements are preferably rods, in particular round and/or made of stainless steel. Alternatively, the insertion elements can be made of L-shaped tray angles in particular. The insertion elements are preferably fixed elements, i.e. in particular not drawers or other movable elements.

The hinging rack preferably comprises a left and a right rack part, wherein each insertion element comprises an insertion element in the left rack part and an insertion element in the right rack part. The two rack parts of the hinging rack are preferably two independent components, each of which can be fixed to the opposite inner surfaces of the food receiving chamber, in particular to the inner sides of an inner chamber wall of the food treating device. Alternatively, the hinging rack can also be an integral part of the inner chamber wall of the food receiving chamber, for example by means of a corresponding contour at an inner wall.

At least two of the insertion zones of the hinging rack are adapted as so-called “complete insertion zones”. So-called “partial insertion zones” are also described as an optional design of the hinging rack. Preferably, at least three, in particular at least four of the insertion zones are adapted as “complete insertion zones”.

Each complete insertion zone comprises at least a first insertion and a second insertion. A third slide-in zone is described as an optional embodiment. Particularly preferably, the respective complete insertion zone comprises exclusively the first insertion and the second insertion or exclusively the first insertion, the second insertion and the third insertion.

For each first insertion, the opposing insertion elements have a first horizontal distance from one another. For each second insertion, the opposing insertion elements have a second horizontal distance from one another. Preferably, the first horizontal distance is greater than the second horizontal distance.

In the present case, horizontal distances always refer to the clear distance. Directions and orientations always refer to the usual use of the hinging rack in the food receiving chamber. For example, the individual insertion elements extend in horizontal direction from a front side to a rear side. The front side is the side of the hinging rack, at which the food carriers are arranged and inserted. When in use, the front side of the hinging rack is arranged at an opening of the food receiving chamber.

Different food carriers, in particular trays or gastronomic containers, are usually used for storing and handling food. These food carriers comprise an edge that merges into a bottom of the food carrier with a corresponding depth. The edges of the food carrier come to rest on the insertion elements. There must be enough space for the food carrier between the opposite insertion elements. The different food carriers can have different widths; it is of particular interest here that the food carriers have a lateral wall at the transition from the edge to the bottom. The distance between these walls determines in particular the width of the food carrier that is relevant here. A wide food carrier can thus be inserted into the first insertion and narrower food carriers into the second insertion, as the first horizontal distance is greater than the second horizontal distance.

The arrangement of the insertions in individual insertion zones makes the hinging rack as easy as possible for the user to use. The user only has to select the insertion zone, into which the food carrier is to be inserted. Within the insertion zone, the user then finds the appropriate insertion for the respective type of food carrier.

Preferably, the first insertion is arranged above the second insertion. However, the order can also be reversed, so that the second insertion is arranged above the first insertion.

As already mentioned, it is preferable for each complete insertion zone to comprise a third insertion element, at which the opposing insertion elements have a third horizontal distance from one another. When three insertions are used, the second insertion is preferably arranged between the first insertion and the third insertion. The first insertion is therefore at the top, the second insertion in the middle and the third insertion at the bottom. Alternatively, the second insertion is at the top, the first insertion in the middle and the third insertion at the bottom.

The second horizontal distance is preferably the same as the third horizontal distance. In this way, food carriers with the same width can be inserted into the second insertion and the third insertion. It is also taken into account here that food carriers can comprise different depths (measured in the vertical direction). For example, a food carrier can be relatively flat and thus comprise a depth of only 1 to 2 cm from its edge to its bottom. However, there are also deeper food trays that comprise a depth of 6.5 cm, for example. These deeper food carriers are preferably inserted into the second insertion and are thus arranged slightly higher than when they are inserted into the third insertion. As a result, the deeper food carriers do not protrude or do not protrude as far into the insertion zone lying below. For example, it is possible to insert a deep food carrier in the insertion zone into the second insertion, wherein sufficient space remains in the insertion zone lying below to also insert a food carrier there.

It is preferable that the insertion elements of the second insertion of each insertion zone, when the insertion zone comprises a second insertion, protrude further forward, i.e. in the direction of the opening of the food receiving chamber, than the insertion elements of the first insertion and, when a third insertion is used in the insertion zone, than the insertion elements of the third insertion. The second insertion, which is arranged in the center of a complete insertion zone, is the preferred insertion to be used. In order to facilitate the user to use this second insertion and to make it easier to arrange the food carrier, the insertion elements of the second insertion preferably protrude further forward than the insertion elements of the other insertions.

For this purpose, it is particularly provided that the hinging rack comprises a vertical first holding element on both sides, i.e. in particular in the right rack part and in the left rack part, and a vertical second holding element. The vertical first holding element is arranged further back than the vertical second holding element. Preferably, the front ends of the insertion elements of the first insertion element and/or the third insertion element are fixed to the first holding element. The front ends of the insertion elements of the second insertion are preferably fixed to the second holding element.

In particular, the holding elements, just like the insertion elements, are rods made of metal. Accordingly, the holding elements and the insertion elements can be welded together. In addition to the two holding elements described, the hinging rack can also comprise other, in particular vertical, holding elements to firmly connect the individual insertion elements to each other.

Vertical distances are defined in the following. These are always measured to the upper sides of the individual insertion elements, i.e. to the sides or surfaces, at which the food carrier rests.

Preferably, a vertical zone distance between adjacent insertion zones is defined. This zone distance describes the distance between the uppermost insertion of an insertion zone and the lowermost insertion of the insertion zone lying above it. The vertical zone distance is preferably greater, in particular by at least 1.3 times, than any vertical insertion distance between adjacent insertions within the insertion zones. The insertions within the insertion zones are thus closer together than the insertion zones are spaced apart. This allows the insertion zones to be clearly visually distinguished from one another.

Preferably, the hinging rack comprises an upper partial insertion zone and/or a lower partial insertion zone. It is provided that the partial insertion zones are provided in addition to the at least two complete insertion zones.

The upper partial insertion zone comprises fewer insertions than each individual complete insertion zone. It is particularly preferred that the upper partial insertion zone comprises only one insertion, namely the third insertion described above.

The lower partial insertion zone also comprises fewer insertions than each individual complete insertion zone. In particular, it is provided that the lower partial insertion zone comprises only the first insertion and the second insertion.

Via one or both lower partial insertion zones at the lower or upper end of the hinging rack, the available space in the food receiving chamber can be optimally utilized.

Preferably, the hinging rack comprises a vertical marking bar at the front side with markings for optical identification and differentiation of the individual insertion zones by the user. In particular, it is provided that only the insertion zones, but not the individual insertions, are provided with corresponding markings. The markings are in particular numbers. The marking bar is in particular a sheet strip. This sheet strip preferably comprises cut-out or printed markings, in particular numbers.

The invention further refers to a food treating device. In particular, this is a cooking device, a cooling device or a warming device. The food treating device comprises the food receiving chamber and the described hinging rack, which is arranged in the food receiving chamber. The hinging rack can preferably be inserted into the food receiving chamber tool-free and can be detached again, so that the food receiving chamber can be cleaned easily.

The food receiving chamber comprises an opening. This opening can preferably be closed by a door of the food treating device. The food carriers are inserted into the hinging rack via this opening. Optional embodiments of the hinging rack, as described in the present description and/or in the claims, can be correspondingly advantageously used for the food treating device.

The invention further refers to a method of operating a food treating device with a hinging rack. In particular, the hinging rack is the hinging rack described in this description and/or in the claims.

The hinging rack, which is used in the method, is arranged in the food receiving chamber. The hinging rack comprises a plurality of the insertion zones arranged one above the other, wherein at least two of the insertion zones each comprise a first insertion for inserting a food carrier of a first type and a second insertion arranged below or above the first insertion for inserting a food carrier of a second type. As described in the context of the hinging rack, the individual insertion zone can in particular also comprise the third insertion. Furthermore, it is in particular provided that the zone distance of adjacent insertion zones is greater than any vertical zone distance between adjacent insertions within the insertion zones.

According to the method, it should be detected as precisely as possible, into which insertion a food carrier is inserted and/or from which insertion the food carrier is removed. It is not of decisive importance that the insertion is detected with 100 percent accuracy. The aim is merely to determine with sufficient probability, into which insertion the food carrier is inserted or removed. The following steps of the method are provided for this purpose:

In particular, the method provides that a food carrier, in particular a tray, with food arranged thereon, is inserted into the hinging rack or removed from the hinging rack. Furthermore, the method provides that a camera and/or a distance sensor is/are provided, which is/are connected with a control device arrangement for data exchange. The camera and/or the distance sensor is/are preferably arranged at the food treating device.

The control device arrangement can be an individual control device with one or more computing units. However, the term control device arrangement also comprises several control devices and/or different computing units that are networked together. The control device arrangement can also be arranged partially or completely outside the food treating device, for example in a server.

The method provides for detecting an insertion height of a food carrier inserted into the hinging rack or a food carrier removed from the hinging rack via the camera and/or the distance sensor in connection with the control device arrangement. This takes place in particular while the food carrier is inserted into the food receiving chamber or removed from the food chamber. When detecting an insertion height, the distance between the food carrier and the camera or distance sensor is recorded in particular. When no separate distance sensor is used, this insertion height or distance can also be identified via the camera image. For example, the control device arrangement knows the width of the food receiving chamber or the width of suitable food carriers. The overall width of the food carrier can be detected in the camera image; when this width appears correspondingly large on the camera image, the distance to the camera is correspondingly small, whereas when the width of the food carrier is small on the camera image, the distance to the camera is correspondingly larger. Under these conditions, the distance to the camera can be identified from the camera image. However, other methods are also possible in order to at least approximately detect the distance to the inserted food carrier and thus the insertion height via the camera.

It is further provided that the type of food carrier inserted is detected via the camera and/or the distance sensor in connection with the control device arrangement. In particular, this takes place while the food carrier is inserted into the food receiving chamber. Methods for detecting the type of food carrier inserted or removed will be explained in more detail.

In the method, it is taken into consideration that detecting an insertion height cannot be so accurate that the respective insertion can be identified within an insertion zone. However, tests have shown that detecting the insertion height can at least identify, which insertion zone is being inserted into. The exact assignment for insertion within the insertion zone can be made by taking into account, which type of food carrier is inserted or removed. If, for example, it is detected that a food carrier of a first type is being inserted or removed, and when it is stored in the control device arrangement that a food carrier of the first type can only be inserted into the first insertion—or is usually inserted into the first insertion—it can be concluded from this, when the insertion zone is known, into which specific insertion was inserted or from which specific insertion was removed.

The method therefore provides via the control device arrangement the performing of the following:

Assigning the insertion zone to the inserted or removed food carrier based on the detected insertion height and assigning the inserted or removed food carrier to the used insertion within the assigned insertion zone based on the detected type of food carrier.

The control device arrangement stores, which insertion zone is arranged at which insertion height or insertion height range, and which type of the food carrier is to be assigned to which insertion. As mentioned at the beginning, the method does not have to assign the correct insertion 100 percent of the time, but should only do so with a sufficiently high probability. In this respect, it is also not relevant, for example, when a food carrier of a certain type fits into different insertions, provided that the control device arrangement stores, for example, the insertion, into which such a type of food carrier is usually or mostly used.

After assigning the inserted or removed food carrier to a specific insertion within a specific insertion zone, the method preferably comprises displaying the assigned insertion and/or the assigned insertion zone, and/or controlling the food treating device based on the assigned insertion and/or the assigned insertion zone. Both the displaying and the controlling can be carried out via the control device arrangement. For the displaying, it is particularly intended that the control device arrangement controls a displaying of the food treating device. Controlling the food treating device based on the assigned insertion and/or the assigned insertion zone means, for example, that a corresponding cooking program for treating the food is automatically selected and started or ended.

The following describes possible method steps for detecting the type of food carrier. These method steps can be used individually or in combination with each other. In particular, the combination of several of these steps makes it possible to make detecting more precise:

(i) Detecting the type of food carrier thus comprises identifying the depth of the food carrier. This in turn is done by identifying the distance of the edge of the food carrier and the bottom of the food carrier from the camera or the distance sensor. This is done in particular while the food carrier is inserted into or removed from the food receiving chamber. For example, the measured or identified distance is observed over time. When the food carrier is inserted or removed, the camera or distance sensor first detects the distance to the edge of the food carrier and then the distance to the bottom of the food carrier. A difference can be identified from the two distances, which essentially corresponds to the depth of the food carrier. The control device arrangement can store which difference is assigned to which type of food carrier. This makes it possible, for example, to detect that a deep food carrier, for example with a depth of 6.5 cm, has been inserted or removed. It can be stored in the control device arrangement that such a type of food carrier is preferably inserted into the first insertion.

(ii) Furthermore, it is possible to enable detecting the type of food carrier via an image recognition software based on photographs of the food carrier or parts of the food carrier from the camera. For this purpose, the image recognition software can, for example, compare parts of the captured image with a database and thereby detect what type of food carrier it is.

(iii) In addition, it is also possible to deduce what type of food carrier it is based on the detected food arranged on the food carrier. For example, when it is detected that potatoes are inserted or removed, it can be concluded with sufficient probability that it is a deep food carrier. When, on the other hand, it is detected that bacon strips, for example, are being inserted or removed, it can be concluded that it is a shallow food carrier. Thus, the method preferably provides for detecting the type of food carrier by recognizing which type of food is arranged on the food carrier. This is also done via an image recognition software based on photographs of the food or parts of the food via the camera, wherein it is stored in the control device arrangement which type of food carrier is used for the recognized food.

The invention further refers to a food treating device. This is adapted in particular for performing the method described. The food treating device is in particular a cooking device, a warming device or a cooling device. The food treating device comprises a food receiving chamber. The hinging rack is arranged in this space. In particular, this refers to the hinging rack as defined in the present description and/or the claims. As has been described in the context of the method, the hinging rack is arranged in the food receiving chamber and comprises a plurality of insertion zones arranged one above the other, wherein at least two of the insertion zones each comprise a first insertion for inserting a food carrier of a first type and a second insertion arranged below or above the first insertion for inserting a food carrier of a second type.

Further, the food treating device comprises the control device arrangement as defined in the method.

The food treating device comprises the camera and/or the distance sensor, which, together with the control device arrangement, are adapted to detect the insertion height of a food carrier inserted into the hinging rack and/or of a food carrier removed from the hinging rack, in particular while the food carrier is being inserted into or removed from the food receiving chamber. Furthermore, the camera and/or the distance sensor together with the control device arrangement are adapted to detect the type of food carrier inserted and/or removed, in particular while the food carrier is being inserted into the food receiving chamber.

The control device arrangement is adapted for assigning the insertion zone to the inserted food carrier and/or to the removed food carrier based on the detected insertion height and for assigning the inserted food carrier and/or the removed food carrier to the used insertion within the assigned insertion zone based on the detected type of food carrier. Furthermore, the control device arrangement is adapted to display the assigned insertion and/or the assigned insertion zone, and/or to control the food treating device based on the assigned insertion and/or the assigned insertion zone.

The camera and/or the distance sensor are arranged on the food treating device in particular in such a way as to detect the food carriers while they are being inserted and/or while they are being removed in the section of the opening of the food receiving chamber. In particular, the camera and/or the distance sensor are arranged in the section of the opening of the food receiving chamber.

### BRIEF DESCRIPTION OF THE DRAWINGS

Further details, advantages and features of the present invention are apparent from the following description of an embodiment with reference to the drawing. It shows in:

FIG. 1 a schematic view of a food treating device of the invention with a hinging rack of the invention for performing the method of the invention according to an embodiment,

FIG. 2 the hinging rack of the invention inside the food treating device of the embodiment,

FIG. 3 the hinging rack of the invention according to the embodiment,

FIG. 4 a side view of the right rack part of the hinging rack of the invention according to the embodiment,

FIG. 5 a perspective view of the right rack part of the hinging rack of the invention according to the embodiment, and

FIG. 6 a schematic view of the method of the invention according to the embodiment.

### DETAILED DESCRIPTION

In the following, a food treating device 100 with a hinging rack 1 arranged therein is described with reference to the figures. The food treating device 100 is used for performing a method 200. Unless otherwise mentioned in detail, reference is always made to all figures in the following.

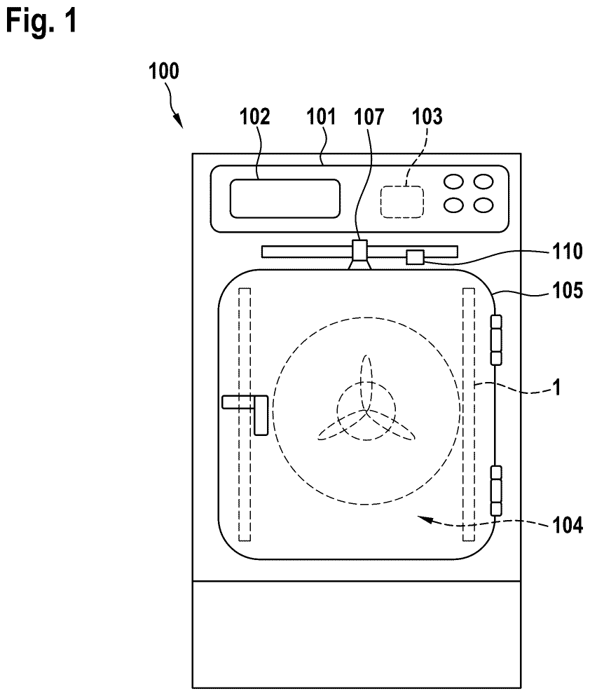

FIG. 1 shows a schematic view of the food treating device 100, here adapted as a cooking device, in particular a combi-steamer. The food treating device 100 comprises a control unit 101, in which a display 102 is arranged. A control device arrangement 103 is arranged inside the food treating device 100. The control device arrangement 103 can also be partially or completely arranged outside the food treating device 100, for example in a server.

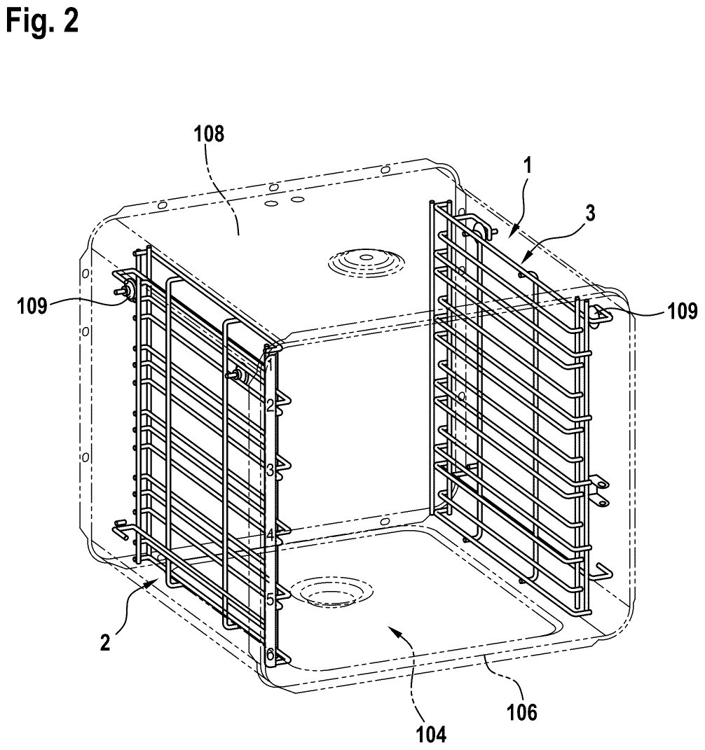

The food treating device 100 comprises a food receiving chamber 104, which is closed by a door 105. The door 105 closes an opening 106 (see FIG. 2) of the food receiving chamber 104. A camera 107 and a distance sensor 110 are arranged in the section of the door 105 or the opening 106. This camera 107 films the section of the opening 106. The distance sensor 110 detects the section of the opening 106. Instead of the distance sensor 110 shown or in addition thereto, the camera 107 can be used to detect the distance to inserted food carriers.

A hinging rack 1 is arranged in the food receiving chamber 104.

FIG. 2 schematically shows an inner chamber wall 108 of the food receiving chamber 104 and rack holders 109 for fixing and releasing the hinging rack 1 tool-free are arranged at the sides and opposite this inner chamber wall 108.

The hinging rack 1 comprises a left rack part 2 and a right rack part 3.

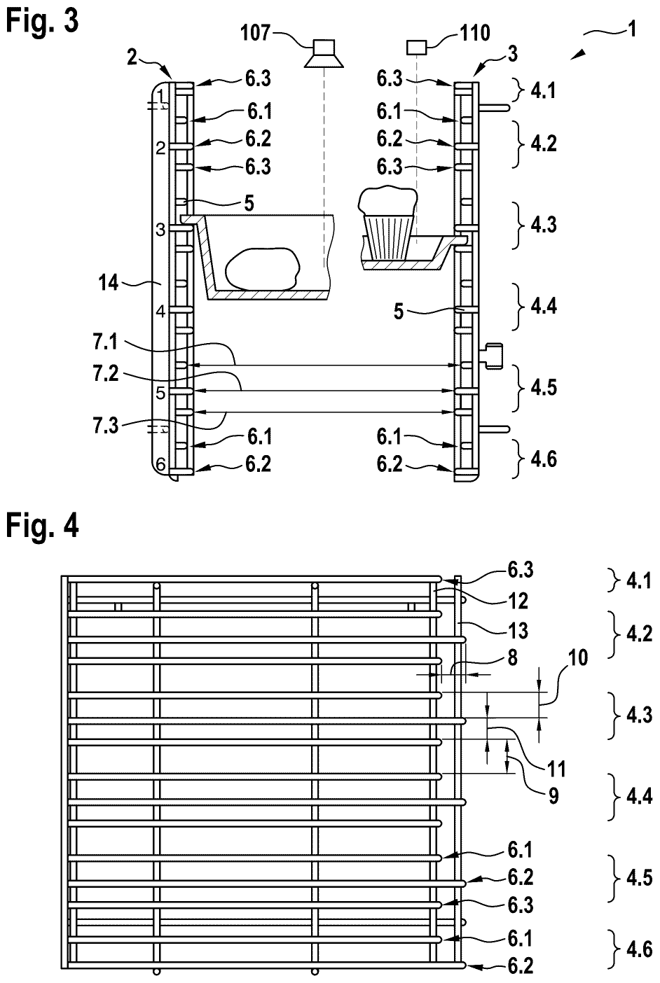

FIG. 3 shows the hinging rack 1 with the left rack part 2 and the right rack part 3. The horizontal distance between the two rack parts 2 and 3 is not shown to scale in order to keep the illustration clear.

The hinging rack 1 comprises six insertion zones 4.1 to 4.6 arranged one above the other.

The insertion zones 4.2 to 4.5 are complete insertion zones. Each of these insertion zones 4.2 to 4.5 comprises a first insertion 6.1, a second insertion 6.2 and a third insertion 6.3. Each insertion 6.1 to 6.3 is composed of a pair of opposing insertion elements 5, here adapted as fixed stainless steel rods.

The first insertion zone 4.1 at the upper end of the hinging rack 1 is adapted as an upper partial insertion zone. This comprises only the third insertion 6.3.

The sixth insertion zone 4.6 at the lower end of the hinging rack 1 is adapted as a lower partial insertion zone and comprises only the first insertion 6.1 and the second insertion 6.2.

FIG. 3 schematically shows a first horizontal distance 7.1 between the opposing insertion elements 5 of the first insertion 6.1. Accordingly, the second horizontal distance 7.2 of the second insertion 6.2 and the third horizontal distance 7.3 of the third insertion 6.3 are also shown. The second and third horizontal distances 7.2, 7.3 are equal. The first horizontal distance 7.1 is greater than the second and third horizontal distances 7.2, 7.3.

FIG. 4 shows the side view, exemplary for the right rack part 3. However, the following embodiments also apply to the left rack part 2. According to FIG. 4, the insertion elements 5 of the second insertion 6.2 protrude further forward with an offset 8 than the insertion elements 5 of the first insertion 6.1 and the third insertion 6.3. Furthermore, FIG. 4 shows that the hinging rack 1 comprises a first holding element 12 and a second holding element 13. The two holding elements 12, 13 are vertically aligned rods. The insertion elements 5 of the first and third insertions 6.1, 6.3 are fixed to the first holding element 12. The insertion elements 5 of the second insertions 6.2 are fixed to the second holding element 13. As FIG. 4 shows, the hinging rack 1 can also comprise further vertical holding elements for the fixed arrangement of the insertion elements 5.

FIG. 4 also shows a zone distance 9 between the first insertion 6.1 of each insertion zone and the third insertion 6.3 of the insertion zone directly lying above it. In addition, FIG. 4 shows an upper insertion distance 10 between the first insertion 6.1 and the second insertion 6.2 within each complete insertion zone and a lower insertion distance 11 between the second insertion 6.2 and the third insertion 6.3 within each complete insertion zone. The zone distance 9 is greater than each insertion distance, i.e. in particular the upper insertion distance 10 and the lower insertion distance 11.

FIG. 3 shows that the hinging rack 1 can comprise a marking bar 14 on at least one side. Here, the marking bar 14 is a sheet strip with cut-out numbers for marking the insertion zones 4.1 to 4.6. Alternative marking techniques, such as etching, etc., are possible.

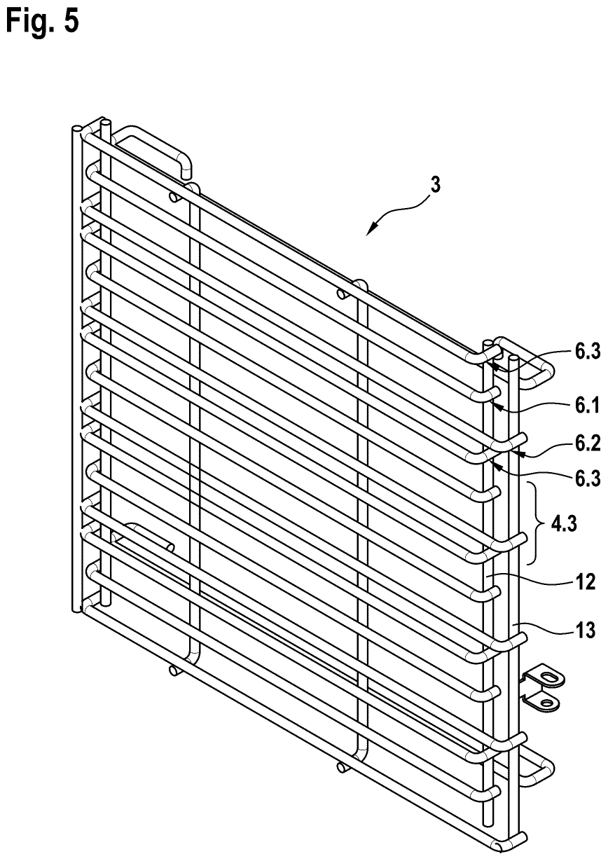

FIG. 5 shows the right rack part 3 in a perspective view.

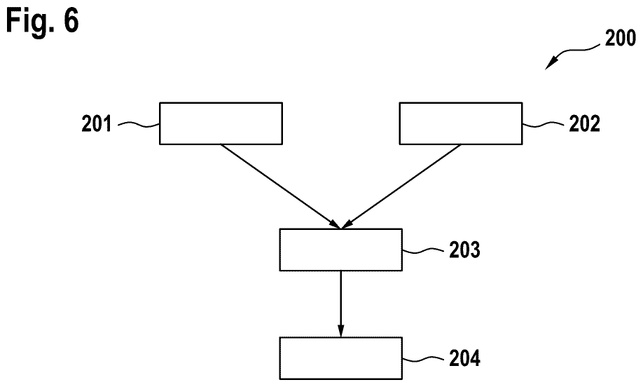

FIG. 6 schematically shows the method 200. The method 200 is the method as explained in the general part of the description, with the following steps:
201: detecting an insertion height of a food carrier inserted into the hinging rack 1 or of a food carrier removed from the hinging rack 1 via the camera 107 and/or the distance sensor 110 in connection with the control device arrangement 103,
202: detecting the type of food carrier inserted or removed via the camera 107 and/or the distance sensor in connection with the control device arrangement 103,
203: assigning, via the control device arrangement 103, the insertion zone 4.1 to 4.6 to the inserted or removed food carrier based on the detected insertion height and assigning, via the control device arrangement 103, the inserted or removed food carrier to the insertion 6.1 to 6.3 to be used within the assigned insertion zone 4.1 to 4.6 based on the detected type of food carrier, wherein it is stored in the control device arrangement 103, which insertion zone 4.1 to 4.6 is arranged at which insertion height and which type of food carrier is to be assigned to which insertion 6.1 to 6.3,
204: displaying the assigned insertion 6.1 to 6.3 and/or the assigned insertion zone 4.1 to 4.6, and/or controlling the food treating device 100 based on the assigned insertion 6.1 to 6.3 and/or the assigned insertion zone 4.1 to 4.6 via the control device arrangement 103.

FIG. 3 shows in the left half a deep food carrier—here a GN container with a depth of 65 mm and potatoes arranged thereon. In the right half, FIG. 3 shows a shallow food carrier—in this case a tray with a depth of 20 mm and muffins arranged on it. It can be seen that the depth of the food carrier can be a multiple of the insertion distances 10, 11. Therefore, in the method presented here, it is preferable to take into account the type of food carrier, and in particular its depth, when assigning the insertion.

What is claimed is:

1. A hinging rack for inserting food carriers, in particular trays, into a food receiving chamber, the hinging rack comprising:
a plurality of insertion zones arranged one above another, wherein each insertion zone comprises at least one insertion, wherein each insertion comprises a pair of two opposing insertion elements at the same height for inserting a food carrier,
wherein at least two of the insertion zones are formed as complete insertion zones,
wherein each complete insertion zone comprises a first insertion, at which the opposing insertion elements have a first horizontal distance from one another, and
wherein each complete insertion zone comprises a second insertion, at which the opposing insertion elements have a second horizontal distance from one another,
wherein the first horizontal distance is greater than the second horizontal distance.

2. The hinging rack of claim 1, wherein each complete insertion zone comprises a third insertion, at which the opposing insertion elements have a third horizontal distance from one another, wherein the second horizontal distance is preferably equal to the third horizontal distance.

3. The hinging rack of claim 2, wherein the insertion elements of the second insertion protrude further forward than the insertion elements of the first insertion and/or than the insertion elements of the third insertion.

4. The hinging rack of claim 3, comprising on both sides a vertical first holding element, to which the front ends of the insertion elements of the first insertion and/or of the third insertion are fixed, and comprising on both sides a vertical second holding element, to which the front ends of the insertion elements of the second insertion are fixed.

5. The hinging rack of claim 1, wherein a vertical zone distance of neighboring insertion zones is defined as distance of the uppermost insertion of an insertion zone to the lowermost insertion of the insertion zone lying above it, wherein the vertical zone distance is greater than each vertical insertion distance between neighboring insertions within the insertion zones.

6. The hinging rack of claim 1, wherein the uppermost insertion zone is formed as an upper partial insertion zone, which comprises less insertions than each individual complete insertion zone, in particular wherein the upper partial insertion zone comprises only the third insertion.

7. The hinging rack of claim 1, wherein the lowermost insertion zone is formed as a lower partial insertion zone, which comprises less insertions than each individual complete insertion zone, in particular wherein the lower partial insertion zone comprises only the first insertion and the second insertion.

8. The hinging rack of claim 1, comprising a vertical marking bar with markings for optical identification and distinction of the individual insertion zones by a user, in particular wherein the marking bar is formed as a sheet strip with numbers.

9. A food treating device comprising a food receiving chamber having a hinging rack of claim 1 in the food receiving chamber.

10. A method for operating a food treating device comprising a hinging rack in a food receiving chamber,
wherein the hinging rack comprises a plurality of insertion zones arranged one above another, wherein at least two of the insertion zones each comprise a first insertion for inserting a food carrier of a first type and a second insertion arranged below or above the first insertion for inserting a food carrier of a second type,
wherein the method comprises:
detecting an insertion height of a food carrier inserted into the hinging rack or removed from the hinging rack via a camera and/or a distance sensor in connection with a control device arrangement, in particular while the food carrier is inserted into the food receiving chamber or removed from the food receiving chamber,
detecting the type of the inserted food carrier via the camera and/or the distance sensor in connection with the control device arrangement, in particular while the food carrier is inserted into the food receiving chamber or removed from the food chamber,
assigning, via the control device arrangement, the insertion zone to the inserted or removed food carrier based on the detected insertion height, and assigning, via the control device arrangement, the inserted or removed food carrier to the used insertion within the assigned insertion zone based on the detected type of the food carrier, wherein the control device arrangement stores which insertion zone is arranged at which insertion height and which type of the food carrier is to be assigned to which insertion, and
displaying the assigned insertion and/or the assigned insertion zone, and/or controlling the food treating device based on the assigned insertion and/or the assigned insertion zone via the control device arrangement.

11. The method of claim 10, wherein detecting the type of the food carrier comprises:
detecting the depth of the food carrier by detecting the distance from the camera and/or distance sensor to the edge of the food carrier and the distance from the camera and/or distance sensor to the bottom of the food carrier, in particular while the food carrier is inserted into the food receiving chamber or removed from the food chamber, and detecting the type of the food carrier based on the difference of the distance to the edge and the distance to the bottom, wherein the control device arrangement stores which difference is assigned to which type of food carrier, and/or
detecting the type of the food carrier via an image recognition software based on photographs of the food carrier or parts of the food carrier via the camera, and/or
detecting the type of food on the food carrier via an image recognition software based on photographs of the food or parts of the food via the camera, wherein the control device arrangement stores which type of food carrier is used for the detected food.

12. A food treating device with a food receiving chamber comprising:
a hinging rack in the food receiving chamber, wherein the hinging rack comprises a plurality of insertion zones arranged one above another, wherein at least two of the insertion zones each comprise a first insertion for inserting a food carrier of a first type and a second insertion arranged below or above the first insertion for inserting a food carrier of a second type;
a control device arrangement;
a camera and/or a distance sensor, which together with the control device arrangement are adapted for:
detecting the insertion height of a food carrier inserted into the hinging rack and/or a food carrier removed from the hinging rack, in particular while the food carrier is inserted into the food receiving chamber or removed from the food chamber; and
detecting the type of the inserted food carrier and/or the removed food carrier, in particular while the food carrier is inserted into the food receiving chamber or removed from the food chamber,
wherein the control device arrangement is adapted for assigning the insertion zone to the inserted food carrier and/or to the removed food carrier based on the detected insertion height and for assigning the inserted food carrier and/or the removed food carrier to the used insertion within the assigned insertion zone based on the detected type of the food carrier,
wherein the control device arrangement is adapted for displaying the assigned insertion and/or the assigned insertion zone and/or for controlling the food treating device based on the assigned insertion and/or the assigned insertion zone.

13. The food treating device of claim 12, wherein the camera and/or the distance sensor are arranged to detect the food carriers while the inserting and/or while the removing in the area of the opening of the food receiving chamber.
